(19) United States
(12) Patent Application Publication
(10) Pub. No.: US 2002/0024451 A1
(43) Pub. Date: Feb. 28, 2002

(54) Method of communicating with a cluster of bluetooth devices

(76) Inventor: Armand David Rosenberg, Rehovot (IL)

Correspondence Address: Pepper Hamilton LLP, 600 Fourteenth Street, N.W., Washington, DC, 20005-2004, US

(21) Appl. No.: 09/775,604

(22) Filed: Feb. 5, 2001

Related U.S. Application Data
(63) Continuation-in-part of application No. 09/425,174, filed on Oct. 22, 1999, now Pat. No. 6,249,233.

(51) Int. Cl. B60Q 1/48

(52) U.S. Cl. 340/932.2; 340/539; 340/904; 340/988

(57) ABSTRACT

Methods and apparatus for polling a cluster of devices, which are particularly suited for use in wireless parking systems, are disclosed. An application of the polling method and apparatus to parking enforcement is also disclosed.

### PRIORITY

The following application is a continuation-in-part application of U.S. patent application Ser. No. 09/425,174 filed Oct. 22, 1999.

### FIELD OF THE INVENTION

The present invention relates generally to communications with a cluster of bluetooth devices. More particularly, the present invention relates to a system and method for polling a cluster of bluetooth devices.

### BACKGROUND OF THE INVENTION

Parking restriction through use of parking meters and other pay for parking devices serve a number of purposes. One purpose is that of traffic flow management. By restricting the amount of time a car may legally park in a spot before the driver is required to return to the car to “feed” the meter, drivers are encouraged to use their cars in these areas only for short term parking purposes. Meters therefore alleviate to some extent the congestion of automobiles in high density locations such as New York City.

Parking meters and other pay for parking devices also serve the function of revenue generation. In municipal parking facilities the revenue collected from the parking devices exceeds the cost to maintain the parking facility thereby providing revenue to the municipality.

In order to achieve the above-stated and other purposes served by parking meters and other pay for parking devices it is necessary to enforce the parking restrictions and ensure payment is made for the parking. The traditional, and still most widely used, method of enforcing parking restrictions is to have an enforcement agent patrol the streets or parking facility and issue summonses for parking violations. While it is not possible to catch all violators, in order to provide sufficient enforcement presence and thus adequate deterrence, municipalities frequently must have large numbers of enforcement agents which is a substantial overhead cost.

Numerous methods and devices have been developed to improve enforcement of parking restrictions while simultaneously limiting the optimal number of enforcement agents needed to achieve the stated deterrent effect. For example, parking meters have been developed which include hardwired or wireless communication circuitry which notifies a central monitoring entity when time has expired on a meter. An enforcement agent can then be dispatched to the meter to issue a summons.

While the currently developed parking enforcement systems provide advantages over previous systems, they still suffer drawbacks. The primary drawback is the infrastructure cost borne by the municipality in installing equipment of the type described. Because of the nature of such equipment it is not possible to roll-out the introduction of these systems while slowly replacing existing equipment.

A need still exists, therefore, for a parking enforcement system which can be used to reduce the manpower required to enforce parking restrictions and which can be rolled-out incrementally.

### SUMMARY OF THE INVENTION

The foregoing needs have been satisfied to a great extent by the present invention wherein, in one aspect of the invention, a method of enforcing parking restrictions is provided wherein a registration request message is broadcast from an enforcement unit to a plurality of teleparking units. A registration response message is then received at the enforcement unit from each of the plurality of teleparking units. Each of the teleparking units are then interrogated in response to said response messages.

In another aspect of the invention, a method is provided for enforcing parking restrictions wherein a Bluetooth transmission of a registration request message is received at a teleparking unit from an enforcement unit. A registration response message is transmitted from the teleparking unit to the enforcement unit. An interrogation message is then received at the teleparking unit in response to the transmitted registration response message. Data representative of the parking authorization status is also transmitted from the parking unit to the enforcement unit.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram representation of a parking network including a parking enforcement unit of a preferred embodiment of the present invention.

FIG. 2 is a signal timing diagram depicting the exchange of signals between the enforcement unit and a teleparking unit of a preferred embodiment of the present invention.

### DETAILED DESCRIPTION OF PREFERRED EMBODIMENTS OF THE INVENTION

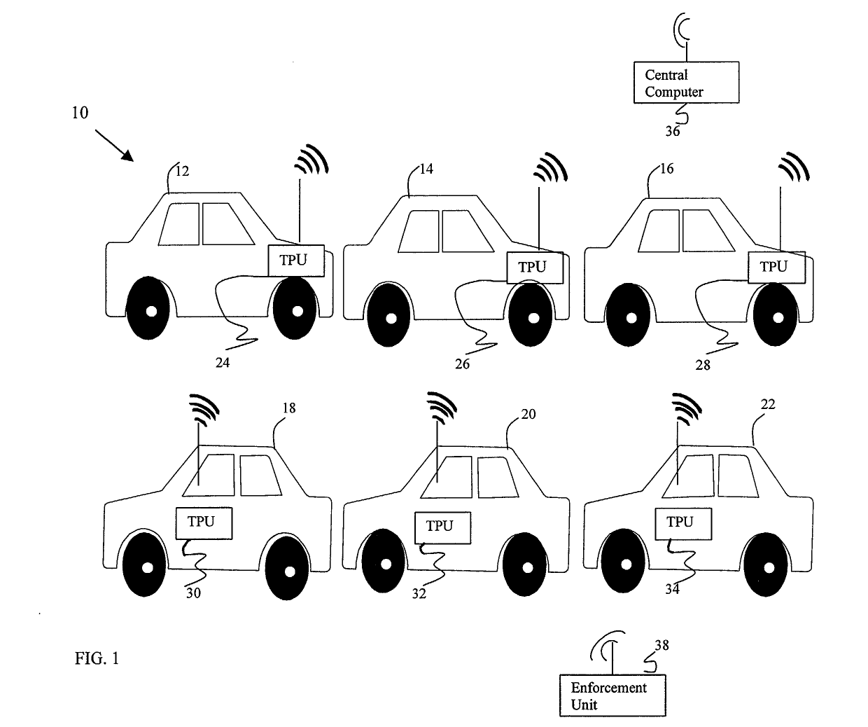

Referring now to the figures, wherein like reference numerals indicate like elements, in FIG. 1 there is shown a block diagram of a parking system 10 in accordance with a preferred embodiment of the present invention. The parking system includes a plurality of automobiles 12, 14, 16, 18, 20 and 22 which are provided with teleparking units 24, 26, 28, 30, 32, and 34, respectively. Also provided in the parking system are one or more central computers 36 and one or more enforcement units 38.

The teleparking units 24-34, inclusive, can be any devices that are capable of wirelessly transmitting requests to the central computer 36 for parking authorization and are capable of receiving wireless messages from the central computer 36 authorizing parking. Preferred examples of the teleparking units 24-34 are described in co-pending application Ser. No 09/425,174, filed Oct. 22, 1999, the disclosure of which is incorporated herein by reference. These devices include cellular phones, message recorders, pagers, private alarms, vehicle location units, and the like, coupled permanently or temporarily via wireless connection or hardwire connections to circuitry providing the parking functionality. It should be readily apparent that the foregoing examples of teleparking units 24-34 are merely illustrative and are not meant to be limiting.

In one preferred embodiment that is particularly suited to the present invention, the teleparking units 24-34 are integrated devices containing the tranceiver circuitry and the parking circuitry. The device may also include other circuitry such as Global Positioning System (GPS) circuitry as provided in vehicle location units. The teleparking units 24-34 are thereby capable of communicating with the central computer 36 to request and obtain parking authorization as described in co-pending application Ser. No. 09/425,174, filed Oct. 22, 1999, the disclosure of which is incorporated herein by reference. It should be recognized that, while not depicted as such, the central computer wirelessly connects to the teleparking units over transmission facilities such as a cellular telephone system, a pager network, or a satellite communication network as described in the co-pending Ser. No. 09/425,174 application.

In the presently preferred embodiment, the teleparking units 24-34 are also provided with circuitry permitting the reception and transmission of wireless radio frequency signals from and to the enforcement unit 38. In a particularly preferred embodiment transmissions between the teleparking units 24-34 and the enforcement unit over the frequencies 2.4000 to 2.4835 GHz band in accordance with the Bluetooth specification. Details of the Bluetooth specification are readily available, e.g., at www.bluetooth.com, and are incorporated herein by reference.

As provided in the Bluetooth specification, the transmitters can be set to provide between 1 and 100 milliwatts of power thus providing an effective tranmission range of 0.1 to 10 meters. Thus, it should be understood that by setting the transmission power for the Bluetooth communications in both the teleparking units 24-34 and the enforcement unit 38 at an appropriate level, an enforcement unit 38 being operated by a parking enforcement agent standing in one location can communicate simultaneously with a number of teleparking units 24-34. Given the average length of an automobile and with the enforcement unit transmitting an omni-directional signal, it is possible for an enforcement agent to interrogate the teleparking units 24-34 of up to fifteen automobiles without having to change locations.

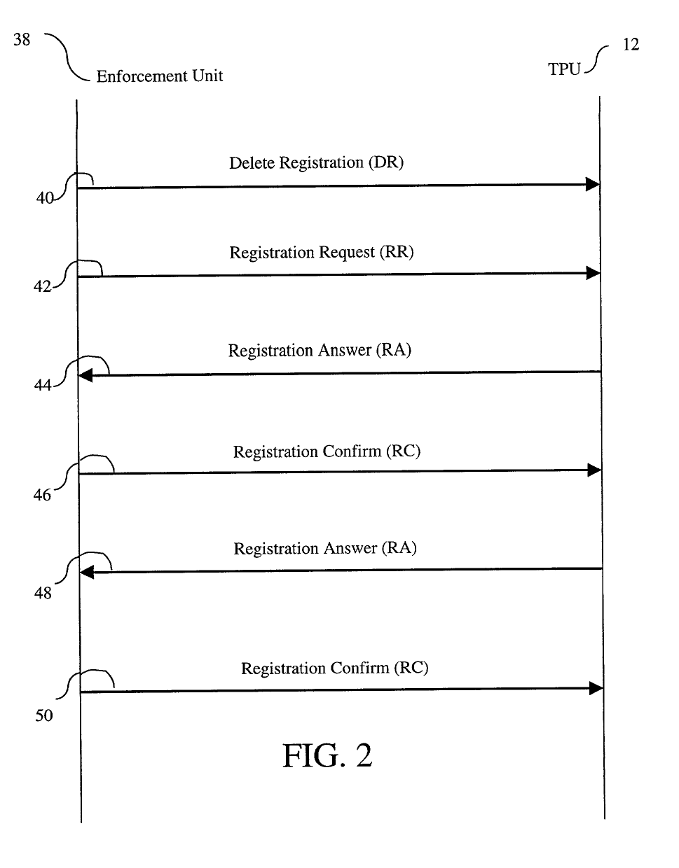

Referring now to the timing diagram of FIG. 2, the method of handshaking with the transceiver of a teleparking unit 24 by an enforcement unit 38 will now be explained. In accordance with the Bluetooth specification when the enforcement unit 38 comes in range of one or more teleparking units 24-34 a handshaking will be performed by the Bluetooth transceivers to enable communications between the devices. This handshaking must be accomplished with a number of teleparking units 24-34 and thus, the process begins with the enforcement unit 38 first broadcasting a delete registration message 40 to all teleparking units in communication with the enforcement unit 38.

The purpose of the delete registration message is to prepare each teleparking unit 24 to be interrogated by the enforcement unit 38. This preparing may include a command to erase any data relating to prior registrations with other enforcement units. This message may also trigger the teleparking unit 24 to turn on an LED or some other display within the automobile so that the enforcement agent can visually determine quickly which automobiles are responding and, more importantly, which are not. The enforcement agent may then decide to change their location in order to “pick-up” other automobiles within the vicinity.

Following the transmission of the delete registration message 40, the enforcement unit 38 will then broadcast a registration request message 42 to all teleparking units currently in communication with the enforcement unit 38. The registration request message 42 is a command message directing each of the teleparking units 24 to respond with a registration answer message 44. In the preferred embodiment, the registration request message 42 does not contain any data regarding parking authorization.

Each teleparking unit 24 will respond to the registration request message 42 by sending the registration answer message 44 which contains information identifying the teleparking unit 24. Because the enforcement unit cannot receive responses from all teleparking units simultaneously, the responses must be staggered. In a preferred embodiment, the order in which a teleparking units 2434 will respond to the enforcement unit 38 is determined by a random value generated by the teleparking unit 24-34.

In operation, each teleparking unit 24-34 generates a random value and waits to respond a period of time equal to the random number times the guard time. The guard time being equal to one an a half times the message duration.

In a preferred embodiment the teleparking unit 24 is identified by a unique serial number stored within the unit in non-volatile secure memory. The teleparking unit 24 may include an encryption engine to encrypt the serial number for transmission to the enforcement unit 38. These security measures are taken to reduce or eliminate the risk of rogue clone units.

It is envisioned that the teleparking unit 24 can be mounted to the automobile or contained within an existing communication device within the automobile, e.g., a vehicle location device, telematics device, cellular phone, etc., and thus provide a mechanism for associating parking charges with a particular automobile. Alternatively, the device may be incorporated as or within a hand held device which transportable from one vehicle to another, e.g., cellular phone, stand alone parking device, etc.

Advantages of each of these embodiments will be readily understood. For example, the former embodiment may be preferred for work vehicles where a business may wish to associate parking costs with individual vehicles. Also, because the device communicates via radio frequency waves, line of sight communication is not needed in this embodiment as would be required with infrared transmitters. The device can therefore be secured within a dashboard or in the engine compartment of a vehicle out of sight. The latter embodiment may be preferred, however, for use by individuals who own more than one vehicle and only wish to purchase one parking device.

After waiting an appropriate time, the enforcement unit 38 broadcasts a registration confirm messages 46 to the teleparking units 24-34 confirming the serial numbers of the devices that have been registered. Because it is possible that the registration answer messages 44 of more than one device may conflict in time or be transmitted after the enforcement unit 38 stops listening, and thus not be registered, any teleparking units that responded to the original registration request message 42 but were not confirmed 46 will need to retransmit their registration answer message 48. The enforcement unit 38 will again respond after an appropriate time with a second registration confirm message 50. This arbitration process may be repeated a number of times until the enforcement unit does not receive any registration answer messages after sending a registration confirm message.

In an example of the foregoing, where fifteen teleparking units are within range of the enforcement unit, the foregoing process will take two to three seconds. Following the arbitration, each individual teleparking unit 24-34 can then be interrogated individually by the enforcement unit 38 and illegally parked cars identified. A preferred process of interrogating the teleparking units is described in co-pending application Ser. No. 09/425,174, filed Oct. 22, 1999, the disclosure of which is incorporated herein by reference In an alternate embodiment, a token ring arrangement may be used for controlling the timing of transmissions by the teleparking units 24-34 to the enforcement unit for the arbitration and interrogation procedures. Such procedures are well understood by those of skill in the art.

It should be readily recognized that the enforcement unit 38 need not be carried by an enforcement agent. Instead, the enforcement unit 38 can be connected through multiplexing circuitry to one or more beam-steered antennas in appropriate locations in a parking area. By cycling through each of the antennas, all of the cars in a parking area can be interrogated and an enforcement agent dispatched only when it is determined that an automobile is illegally parked.

In yet another embodiment, the teleparking units 24-34 do not communicate with the central computer 36 to register for parking. Instead, the teleparking units 24-34 identify the automobile, or user, associated with the teleparking units 24-34 to the enforcement unit 38 using a handshaking protocol such as that described herein. The enforcement unit 38 then communicates with the central computer 36 to confirm that parking privileges have been obtained for all teleparking units 24-34 present. In this embodiment, parking privileges must be obtained through a mechanism separate from the teleparking units 24-34. For example, parking privileges in this embodiment could be obtained through the use of a separate communication link to the central computer such as by a wireless or landline phone or through a parking kiosk.

The enforcement unit 38 can also be used to issue electronic tickets to users of the teleparking units 24-34 where parking violations are discovered. The enforcement unit 38 can communicate the electronic ticketing information to the central computer 36 so that and fines levied for the parking violation can be included on the users monthly service bill. An indication that a parking violation has been noted can be provided to the user by directing the teleparking unit 24 to light an LED or through some other indicator. This direction to light the LED can be provided by the enforcement unit 38 or by the central computer 36, where communication exists between the central computer 36 and the teleparking units 24-34.

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

What is claimed is:

1. Method of communicating with a cluster of Bluetooth enabled units, comprising the steps of:
broadcasting a registration request message from an polling unit to a plurality of Bluetooth enabled units;
receiving and identifying at said enforcement unit registration response messages from said Bluetooth enabled units; and
interrogating each of said bluetooth units in response to said response messages.

2. The method of claim 1 wherein only a first portion of registration response messages transmitted to said polling unit are received and identified.

3. The method of claim 2 further comprising the step of confirming receipt of said registration response messages from said Bluetooth enabled units by said polling unit.

4. The method of claim 3 further comprising the step of receiving and identifying at said polling unit registration response messages from Bluetooth enabled units for which receipt has not previously been confirmed.

5. The method of claim 4 wherein said interrogating step is not performed until no further registration response messages are received confirming receipt of a registration response message by said polling unit.

6. The method of claim 1 further comprising the step of registering each of said Bluetooth enabled units with said polling unit after said registration response messages are received.

7. The method of claim 6 wherein said interrogating step is not performed until no further registration response messages are received confirming receipt of a registration response message by said polling unit.

8. Method of enforcing parking restrictions, comprising the steps of:
broadcasting a registration request message from an enforcement unit to a plurality of teleparking units;
receiving and identifying at said enforcement unit registration response messages from said teleparking units; and
interrogating each of said teleparking units in response to said response messages.

9. The method of claim 8 further comprising the steps of receiving parking authorization information in response to said enforcement unit during said interrogating step; and
transferring said parking authorization data to a central computer.

10. The method of claim 9 wherein said broadcasting step is accomplished using a Bluetooth transmission.

11. The method of claim 9 further comprising the step of confirming receipt of said regsitration response messages from said teleparking units by said enforcement unit.

12. The method of claim 11 further comprising the step of receiving and identifying at said enforcement unit registration response messages from teleparking units for which receipt has not previously been confirmed.

13. A method of enforcing parking restrictions comprising the steps of:
receiving at a teleparking unit a Bluetooth transmission of a registration request message from an enforcement unit;
transmitting from said teleparking unit a registration response message to said enforcement unit;
receiving an interrogation message at said teleparking unit in response to said transmitted registration response message; and
transmitting, from said teleparking unit to said enforcement unit, data representative of said parking authorization status.

14. The method of claim 13 wherein said transmitting step is performed using a Bluetooth transmitter.

15. The method of claim 14 wherein said Bluetooth transmitter is incorporated in a cellular telephone.

16. The method of claim 13 further comprising the step of indicating visually that said interrogation message is being received.

17. The method of claim 13 further comprising the step of indicating visually that said data representative of said parking authorization status is being transmitted.

18. The method of claim 17 wherein said indicating step is performed using an LED.

19. The method of claim 13 further comprising the step of receiving a confirmation message from said enforcement unit confirming receipt of said transmitted registration response message.

20. The method of claim 19 further comprising the step of transmitting a second registration response message in response to said confirmation message.
